(19) United States
(12) Patent Application Publication
(10) Pub. No.: US 2005/0010598 A1
(43) Pub. Date: Jan. 13, 2005

(54) Method of concurrent visualization of module outputs of a flow process

(76) Inventor: Ravi Shankar, Boca Raton, FL (US)

Correspondence Address: MELVIN K. SILVERMAN, 500 WEST CYPRESS CREEK ROAD, SUITE 500, FT. LAUDERDALE, FL, 33309, US

(21) Appl. No.: 10/856,252

(22) Filed: May 28, 2004

Related U.S. Application Data
(63) Continuation-in-part of application No. PCT/US02/38532, filed on Dec. 3, 2002.
(60) Provisional application No. 60/336,818, filed on Dec. 4, 2001.

(51) Int. Cl. G05B 15/02

(52) U.S. Cl. 707/104.1

(57) ABSTRACT

A method of concurrent visualization of serial and parallel consequences or communication of a flow input to a process module of a flow process includes the steps of: arranging a plurality of process modules in a system and flow relationship to each other; encapsulating each module within an input/output interface through which module operating requirements and process-specific options may be furnished as inputs to the interface, and parallel and series responses to the inputs may be monitored as outputs of the interface, each input/output interface thereby defining a process action of the module of interest, visually mapping by rows, of selected module interface outputs, of a selectable subset of modules of the flow process, to be visualized, the mapping occurring from a common vertical axis, in response to the process-specific input to the interface, in which a horizontal axis of the mapping comprises a parameter of a serial or parallel consequences of the process-specific input; and visually comparing time dependent simulated outputs of the interfaces of the selected subsets of modules to thereby observe serial and parallel consequences of the process-specific input.

### CROSS REFERENCE TO RELATED APPLICATION

This application is a Continuation-In-Part of PCT patent application No. PCT/US02/38532, filed Dec. 3, 2002, which claims the priority of U.S. provisional patent application Ser. No. 60/336,818, filed Dec. 4, 2001. All prior patent applications are hereby incorporated by reference in their entirety.

### BACKGROUND OF THE INVENTION

The present invention relates to the management of a project/process flow. Almost any process that is employed to operate a business or to plan a project can be modeled as a process flow. Such a process flow typically includes a series of business/project steps, or milestones, used to complete the project or operate the business. To illustrate, using a very simple example, consider a typical mail-order business which may employ the following process flow to manage its ordering/shipping process: (1) receive a new order; (2) check exiting inventory for the ordered item; (3) pull ordered item from inventory; and (4) ship the ordered item.

To effectively manage a project or process, many organizations find it useful to model the process flow either visually or electronically. A flowchart is one commonly used approach for visually modeling a process flow. To illustrate, the following flowchart may be used to help manage the mail-order business flow described in the preceding paragraph: 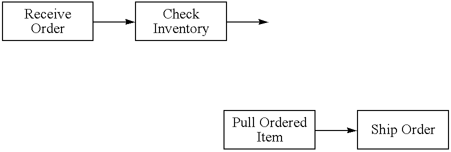
visualize the temporal and logical flow of the series of steps that compose the business process. This, in turn, can lead to more effective management of the project or process. Such modeling should also allow effective optimization and modification of a business process.

However, known approaches for modeling a process are often limited in their scope and capabilities. The extreme complexities of many modern business processes overwhelm the limited abilities of existing modeling tools, which prevent an organization from using that tool to effectively visualize and properly analyze a business process. This inability to effectively model and analyze the process may prevent an organization from being able to determine how or when the business process can be optimized or changed. Therefore, a business process may stay unchanged even though it may be more efficient to modify the process, or the business process may change in a way that does not maximize efficiency.

An example of a modern process that is very complex is the procedure that an electronics company undergoes to develop a new semiconductor chip design. Current chip design, with millions of transistors on a chip and increasingly sophisticated tools, is a challenge that is not easily tracked and documented, as to learn from and improve upon. Chip design flow today is complicated, with EDA (engineering design automation) tools addressing system, digital, analog, RF (radio frequency), software, layout, and other issues.

Similar vendor tools may have proprietary interfaces to each other, and also may provide industry standard interfaces so the designer can mix and match the tools from different vendors. There may be other complicating factors: IC foundries and chip design companies may have their own internal tools using non-standard models and libraries. Furthermore, EDA vendors may push for integration of tools to gain better speed, thus compromising mix and match with other tools. Therein, tool users may feel lost. The project manager and technical leader may have a difficult time deciding which options to choose and which moving targets they can live with, i.e., with a new technology comes new libraries and models.

Given such uncertainties, a typical designer or manager may decide to be conservative and be therefore unwilling to stray from a known design flow and technology. This slows innovation, risk taking, and the product design cycle. To take advantage of the current sophisticated design flow, many pieces of the design puzzle must fall into place. Therein, it is becomes difficult to explore the use of many alternative/advanced/vertically integrated tools. There may exist other constraints to consider, such as time investment in training and library development. One may have to consult many designers and tool experts, on the customer and vendor sides, to make sense of all these criterion.

We use the concept of Legos to illustrate the process. Suppose a structure has been partially built. Then one can use only certain Lego blocks to continue to build. There is no uncertainty here, just certain specific options. So, at each point, the ‘odd’ shape of the previous block(s)—features of that block in a more generic sense—decide which blocks can fit best next. That is the first step. Now, next, one can add different colored blocks—so as to create an aesthetic value. On the other hand, one might have the option of using wood, plastic, or aluminum blocks—one may wish to choose different block types for certain stages, depending upon cost/mobility/power/ease of use/etc., considerations. Thus, a Lego structure built with packed wood may not be as strong as the one with molded plastic, but may be easily available/easily shaped to fit. Engineering considerations may not dictate anything stronger than packed wood. Unlike Lego, a typical real-world problem may have more than 3 or 4 (including time) dimensions, and that is why one needs a concurrent programming technique—since the cause and effects cannot be easily analyzed otherwise.

A method is thus needed to capture the design flow and allow one to explore different options. A modeling approach like flowcharting exists for such purposes; however flowcharts by themselves lack the capacity and are unwieldy for a complex process like modern chip design. An approach using data flow diagrams and its implementation with UML (Unified Modeling Language) also fails to provide sufficient capability to fully manage, analyze, and optimize a complex process.

Notwithstanding such art, a long felt need in the art still exists for a method of visual current simulation of a flow process for:

1. Substitution: one can substitute different vendor tools at the same point of a flow, to perform an apples-to-apples comparison.

2. Customize If a party has internal tools that it desires to plug into a third party flow; it can perform an analysis to determine whether the resulting process performance or result is acceptable.

3. Second source so that a customer can see whether a first vendor's product/process can fit in the flow tailored for another vendor, or whether the first vendor can/should do something different to support the customer.

4. Benchmark to enable organizations to generate industry-wide benchmarking numbers. These organizations may find the present invention useful to do quick “what if” scenarios, or if the results are shared, then parties can fine-tune the customization of modules in the flow. One can also capture information for building a database and improving/fine tuning the performance numbers. Such may include, for example: design complexity versus design productivity; individual designer productivity; and environment productivity.

5. Communicate within and outside of a particular party or vendor to enable use of the invention. Each party in the process can determine and view that party's and all other's role and performance in the overall process.

6. Identify critical paths and execute “what-ifs” with different resources (specific designers, compute facilities and tools).

7. Find the critical chain: From “Theory of Constraints” by Dr. Goldratt. In his book “The Critical Chain, It's not Luck,” Dr. Goldraft identifies the concept of critical chain, which is more than a critical path, and analyzes a resource sharing paradigm. One party could implement that flow and show how the product design cycle time can be reduced.

8. Synthesize and optimize a project across many concurrent paths. Whether it is EDA design flow or the financial world, there are many concurrent activities going on which can influence the final outcome.

9. Capture Knowledge to reduce repeated customer calls on the same topic and to encapsulate knowledge in simple and consistent terms.

10. Add Parameters: Design size and designer experience are example parameters that are used to determine the completion time for each module. Other and additional parameters can be employed in the invention, such as tools, OS versions, and a cell library (new/established).

As such, the current invention comprises a communication management Tool (“CMT”) for use in optimizing communication within a project. While similar to a process flow management tool (“PMT), there are significant differences. A CMT is primarily a manager's tool rather than an engineer's tool since engineering operational details can be incorporated later.

Businesses processes are a complex combination of people, equipment, methods, materials and measures. Changing employees, contractors, vendors, customers, suppliers, regulations, and the like, add dynamic complexity which challenges even the most sophisticated management tools. Traditionally, management has divided business processes into smaller, more manageable parts. Therein, the objective is to maximize or optimize the performance of each part.

To maintain competitiveness, companies must continually invest in technology projects. However, resource limitations require an organization to strategically allocate resources to a subset of possible projects. A variety of tools and methods can be used to select the optimal set of technology projects. However, these methods are only applicable when projects are independent and are evaluated in a common funding cycle. When projects are interdependent, the complexity of optimizing even a moderate number of projects over a small number of objectives and constraints can become overwhelming

In addition, the integrated chip (“IC”) design process is critical to semiconductor and systems companies in the electronics industry. The ability to rapidly design and build complex, multi-million gate chips provides companies with a distinct competitive advantage. Typically, manufacturers now out source the IC fabrication process to third party silicone foundries. This practice has opened up new areas of competition among IC design firms. This makes IC communication optimization even more critical.

In the typical IC design process, a comparison of the normalized transistor count versus project effort in person-weeks, shows that 52% of the engineering effort expended can be attributed to the inherent complexity of the IC design itself. The remaining 48% is attributed to the designer's engineering skills, the design tools/flows/methodology, leadership factors and external factors that are often unpredictable. The CMT optimizes the factors not related to the inherent complexity of the IC design, and therefore helps to control the unpredictable factors.

A process model is an abstract description of an actual or proposed process that represents selected process elements that are considered important to the purpose of the model and can be enacted by a human or machine. It is a documented description of the practices that are considered fundamental to good management and engineering of a business activity. It defines how these practices are combined into processes that achieve a particular purpose.

The two most common process modeling methods are the process dependancy, and data flow diagrams modeling methods (“DFD”). DFD is a modeling methods used to model business processes and the flow of data objects through those processes.

Current process modeling revolves around optimization through the ordering of events within the process. However, currently, there are no tools for facilitating communication between the discrete events. Applicant has developed a communication management tool to assist management of a process. There are several differences between a process flow management tool and a communications management tool. Process flow management focuses on the direction, control and coordination of the work performed to develop a product or perform a service, whereas communications management focuses on communications.

Typical process modeling involves creating a process description which is a detailed description of the process which includes: (1) a critical dependencies between task activities; (2) detailed objectives and goals; (3) expected time required to execute task; (4) functional roles, authorities and responsibilities; (5) input/output work products and constraints; (6) internal and external interfaces to the process; (7) process entry and exit criteria; (8) process measures; (9) purpose of the process; (10) quality expectations; (11) tasks and activities to be performed; and (12) ordering of tasks.

Currently, process modeling is difficult because of incompatibility of tools, languages, data formats, methodologies, and other communication formats (even the vocabulary), which result in process delays.

Software process modeling, is a difficult and complex process typically involving techniques for both continuous systems and discrete systems. Software process modeling facilitates in understanding the dynamics of software development and assessing process strategies. Some examples of process and project dynamics are rapid application development (RAD), the effects of schedule pressure, experience, work methods such as reviews and quality assurance activities, task underestimation, bureaucratic delays, demotivating events, process concurrence, other socio-technical phenomena and the feedback therein. These complex and interacting process effects can be modeled with system dynamics using continuous quantities interconnected in loops of information feedback and circular causality. Knowledge of the interrelated technical and social factors coupled with simulation tools can provide a means for software process improvement.

Software process modeling focuses on (1) developing simulations that address critical software issues; (2) describing the systems thinking paradigm for developing increasingly deep understandings of software process structures; (3) showing basic building blocks and model infrastructures for software development processes; (4) describing the modeling process, including calibration of models to software metrics data.; (5) providing details of critical implementation issues and future research motivations.

Developed by Eliyahu M. Goldratt and Jeff Cox in the book “The Goal: A Process of Ongoing Improvement,” North River Press, MA (1984), the theory of constraints (TOC) claims that optimization of a local process does not necessarily lead to optimization of the overall process. However tools implementing TOC lack the communication capability of the instant invention, to exploit TOC fully.

Process communication Management (PCM) allows the various parts of a business process to communication efficiently, and effectively to optimize the overall performance of the process. Dr. Taibi Kahler is given credit for the development of PCM. He discovered how to identify and respond appropriately to patterns of productive behavior (successful communication) and non-productive behavior (miscommunication) second by second. In 1978 NASA took advantage of this discovery by using PCM in the selection, placement, and training of astronauts. However, PCM has always focused on human interaction, rather than actual communication between processes. In this context, PCM is currently being used successfully as a management tool, as a vehicle to improve salesmanship, as a powerful marketing survey tool, as a dynamic tool for written communication, and as a potent mentoring and learning tool. PCM offers a means of diagnosing individual behaviors within minutes and accurately applying methods to understand, motivate, and communicate more effectively with others. PCM has not been effectively applied to engineering or business processes involving non human interactions.

Another example of the difference in application between PCM and PM is that, where CMT can be used to capture the communication gaps and do cost analysis at the manager level. While PM touches on concepts of cost as a critical constraint, the result is the capture of only the well-defined engineering process. CMT is meant to capture communication across multiple disciplines that traditionally do not communicate with each other, as they do not understand each other's disciplines. Therefore CMT provides a method that allows each sub-process to capture their role in the overall process, in a common language and format, so others can understand and work with them. Thus, an accountant does not have to explain to an engineer how he does his job, he just captures info on his cost, time, input he needs, and the output he provides, in a standard format. Information on his expertise and availability will be added by his manager.

PCM captures well-defined processes, whether engineering or otherwise, in a specific discipline (or two), in a very detailed manner. So, it is an example of local optimization. However, with CMT, managers see the global picture, and modeling of many different disciplines, in terms of their performance and interfacing, as it impacts the big picture. The benefits are that CMT costs significantly less, relative to other methodologies. For example, if a manager modeled the patent litigation process. He would not stop there, but continue and put down the details of each of the forms, the various types of office actions, responses, etc., and continue to refine and incorporate all the details and probably would end up with a PCM model. However, if the manager expanded laterally, to cover other factors that might influence the process, and not just the form details, they would come closer to the CMT model. These influences might include the number of clients, client credibility, and credit rating, and drafting time, expertise and the need for other lawyers' and specialists expertise, etc. CMT can therefore be viewed as the visualization of a multidimensional person with many concurrent (mutually influencing) processes going on, even as related to their job.

Another example: Quicken has a tax software package—it is useful for individual tax payer's tax calculations. It has both a high level and a low level tool, but the high level tool is the only one that is needed by a financial analyst to help understand a client's situation. But the financial analyst also needs other items, such as the economy, legislative initiatives, etc., to decide what to recommend to the client. These are the multi-disciplines that one just intuitively accesses and comes up with a statement for the client. Suppose a major factor is left out by the financial analyst, or he does not think through the time, and cost issues. He could make a wrong recommendation. On the other hand, CMT provides the ability to continue to add factors over a period of time and fine tune the model, all at a higher level.

It is expected that users of the TOC would greatly benefit from CMT tools such as the CMT. A paper published in 2001 on multiple projects used mathematical analysis for optimization. However, CMT could have easily modeled it.

Verilog HDL is a hardware description language used to design and document electronic systems. Verilog HDL allows designers to design at various levels of abstraction. It is the most widely used HDL with a user community of more than 50,000 active designers. Verilog was invented as simulation language, however, designers soon realized that Verilog could also be used for synthesis. An IEEE working group was established in 1993 under the Design Automation Sub-Committee to produce the IEEE Verilog standard 1364. Verilog became IEEE Standard 1364 in 1995. The IEEE standardization process includes enhancements and refinements; to that end the work is being finalized on the Verilog 1364-2000 standard.

VIRTUOSOR LAYOUT EDITOR is a custom layout tool used in IC design process. Although automation tools play a prominent role in today's IC designs, custom layout editing is still used to meet performance and density requirements of critical circuits. VirtuosoR Layout Editor addresses the need for both circuit performance and design productivity with a layout editor that supports digital and analog custom layout editing within a robust design environment.

The Assura family of physical verification tools provides a total solution for physical verification of analog and digital designs for system-on-a-chip implementation. The Assura verification and parasitic extraction tools are tightly integrated into the industry's most widely used custom IC design environments.

TestBuilder is a C++ class library that extends C++ into an advanced test bench development language. TestBuilder extends Verilog and VHDL for developing complex test benches. TestBuilder preserves familiar HDL mechanisms, such as sequential and parallel blocks and event and delay control, and provides additional facilities that you need to develop testbenches.

Several software companies provide TOC related software:

Acacia Technologies (http://www.acaciatech.com) is a division of Computer Associates International, Inc. provides constraint management and drum, buffer, rope scheduling with the Quick Response Engine (QRE) client/server software. The QRE application is fully integrated with its PRMS and KBM ERP systems, and supports interactive and synchronized scheduling for both finite capacity and materials, with simulations and problem resolution capabilities.

i2 Technologies, Inc. (http://www.i2.com/) provides software solutions that directly impact a company's profitability by increasing the responsiveness of the organization's supply chain. i2's decision support software allows a manufacturer and/or distributor to address supply chain management issues from a strategic, operational, and tactical perspective.

ProChain Solutions, Inc. (http://www.ProChain.com/) is easily the leading provider of TOC project management software tools. The tools, education and consulting provided by CTL have enabled their customers to significantly improve their project management processes and performance. Their flagship products are called ProChain (single projects) and ProChain Plus (multiple projects). The ProChain software tools allow the user to apply the Critical Chain approach and provide decision support (buffer management) capabilities. Both software products are designed to use Microsoft Project as the interface. CTL provides software training in both open and dedicated classes. Rob Newbold, one of the developers of this software and a TOC guru, has written a book on TOC Project Management—Project Management in the Fast Lane : Applying the Theory of Constraints.

Maxager Technology, Inc. (http://www.maxager.com/) is the first and only advanced costing solution for component suppliers that bridge the gap between the “cost world” and the “throughput world” by providing Senior Management, Production, Finance, Marketing, and Quality Assurance with real-time information on the actual cost and cash contribution of every product. These detailed reports are generated from PlantCast™, the most advanced and easy-to-use data collection system available.

Scitor Corporation (http://www.scitor.com/) provides a comprehensive, integrated implementation of Critical Chain project management in the PS Suite. Based upon 20 years of experience, the Scitor PS Suite offers a highly scalable, affordable, and extensible solution that maximizes project throughput in resource-constrained environments. The PS Suite provides comprehensive web-based information accessibility to all project stakeholders through the effective management of objectives, portfolios, projects, and resources.

Synchrono (http://www.svnchrono.com/) provides simple TOC solutions to complex supply chain problems. Synchrono's Drum-Buffer-Rope (DBR) and TOC replenishment software is affordable for small manufacturers, yet scalable for large manufacturers. Synchrono offers low-risk, “pay-as-you-go” subscription pricing instead of front-loaded investments in licensed software.

Thru-Put Technologies (http://www.thru-put.com/) has developed a software product called Resonance. Resonance is effective because it utilizes the Drum-Buffer-Rope method authored by Dr. Eli Goldratt in The Goal. Resonance utilizes memory-resident processing for What-If analysis, and instant quotation of order deliveries. It also provides advanced functionality in Master Planning and Production Control to form a complete planning and scheduling system.

Focus 5 Systems Ltd. (http://www.Focus5.mcmail.com/) has been an associate of the Goldratt Institute working with TOC since 1989. Particular emphasis and substantial experience in Production and Project Management. They specialize in the provision of systems to support the implementation of TOC. Distributors for “ProChain” for Critical Chain Project Management and “The Goal System” for Drum-Buffer-Rope Production Management.

Scheduling Technology Group (http://www.stgamericas.com/) are the authors of OPTR—Optimized Production Technology, the original constraint management approach to manufacturing control. STG are specialists in the synchronous finite simulation and planning of the whole manufacturing supply chain including detailed scheduling of the shop floor.

Price Waterhouse Coopers Applied Decision Analysis DPL software (DPL) system differs from the claimed invention in several ways. For example, DPL is defined as a “decision analysis software developed to meet the requirements of decision-makers in business and government. DPL offers an advanced synthesis of the two major decision-making tools, influence diagrams (FIG. 1) and decision trees (FIG. 2), which assist in structuring complete and focused analyses. DPL's powerful solution algorithms and many graphical outputs provide comprehensive and insightful results. DPL is currently being used by over 400 companies, government agencies, universities and research institutes in 31 countries.”<hftp://www.adainc.com/software/whatis.html>. DPL does not appear to support concurrent processing, or inter-process communication as part of its analytical tools. DPL appears to be a sequential decision analysis tool, which helps to develop decision process models, without regard to communication among or between the discrete steps. DPL is good at reducing the number of states for a decision process, not for reordering discrete steps themselves. DPL excels at working with probabilities.

Flores et al, U.S. Pat. No. 5,630,069 (the '069 patent), is a “method and system that provides consultants, business process analysts, and application developers with a unified tool with which to conduct business process analysis, design, and documentation. The invention may be implemented using a software system which has two functional sets. One is a set of graphical tools that can be used by a developer or business analyst to map out business processes. The second is a set of tools that can be used to document and specify in detail the attributes of each workflow definition, including roles, timing, conditions of satisfaction, forms, and links required to complete a business process definition. The invention utilizes fundamental concept of workflow analysis that any business process can be interpreted as a sequence of basic transactions called workflows.” This patent does not discuss concurrent processing. It does however use inter-process communications (IPCs). However, the only discussion of IPCs in the patent specification is as follows: 1. Workflow-Enabled Application: A workflow-enabled application interfaces to the server via the transactions database of the workflow server or via APIs, or via messaging, database, or inter-process communications (IPCs) or through the use of an STF processor. 2. STF Processors: A standard transaction format (STF) processor is an application whose job is to interface external systems to the workflow system. There is one STF processor for each different type of system that interfaces to the workflow system. STF processors can be of three types: message, database, and IPC. The STF processor of FIG. 3 corresponds to a workflow-enabled application type.

The applicant has thereby developed CMT as an inter-process communication management tool, which allows for optimization of serial and parallel processes, regardless of their bias, conflicts between processes, or other process management problems. Currently, there are no CMT, or PCM tools available for project management engineers. Managers have no choice but to rely on current industry process management (PM) tools. The difference between PCM and PM is that while PM focuses on highly complex large processes, PCM works with highly complex smaller, and/or higher level applications. In addition, CMT accomplishes these tasks far more efficiently than the current outdated PCM methodology. For example, PM and PCM would not be applied to Immigration and Naturalization Services form processing or student course advising, while CMT could effectively optimize these processes.

The present invention therefore meets a long felt need in the art to facilitate concurrent communication between serial and parallel process within a larger project to improve the internal operation thereof.

### SUMMARY OF THE INVENTION

A method of concurrent visualization of serial and parallel consequences or communication of a flow input to a process module of a flow process, the method comprising the steps of: (a) arranging a plurality of process modules in a system and flow relationship to each other; (b) encapsulating each module within an input/output interface through which module operating requirements and process-specific options may be furnished as inputs to said interface, and parallel and series responses to said inputs may be monitored as outputs of said interface, each input/output interface thereby defining a process action of said module; (c) providing a process-specific input to said interface of a module of interest; (d) visually mapping, by rows, of selected module interface outputs, of a selectable subset of modules of said flow process, to be visualized, said mapping occurring from a common vertical axis, in response to said process-specific input to said interface, in which a horizontal axis of said mapping comprises a parameter of a serial or parallel consequence of said process-specific input; and (e) visually comparing time dependent simulated outputs of said interfaces of said selected subset of modules to thereby observe serial and parallel consequences of said process-specific input of said Step (c).

A concurrent language, such as the Verilog hardware description language (HDL), can be employed in the invention to capture, model, analyze, and manage a business process. HDL is a low cost tool that supports modular descriptions, allowing concurrent and event driven operations, and also conditional executions and delays, thus satisfying many of the expectations for a new tool. A concurrent language can capture such various scenarios, and using assigned “cost” for each stage, help a manager to make more meaningful and realistic choices, given various constraints. With respect to the chip design process, HDL provides an inexpensive and familiar tool that can be exploited to document, describe, discuss, dissect, and develop chip design flows. However, HDL does not have generic application outside of engineering level design.

It is therefore an object of the invention to serve as a bridge for a communication gap that exists between designers at various levels of the design flow. As an example, the Virtuoso tool, available from Cadence Design Systems, Inc. of San Jose, Calif., provides many methods to enhance analog circuit performance, such as interdigitation and shielding, that many schematic level designers do not take advantage of. With design flow documentation, wizards, and hyperlinks to appropriate documentation, one can be alerted to system possibilities.

It is another object to support design/process management to facilitate concurrency in different parts of the design flow (as an example, simultaneous digital and analog design, and library development).

It is a further object to provide a project management tool, identifying possible project delays (due to time, training, and other parameters) and version control issues.

It is a yet further object to enable a tool vendor to identify synergistic opportunities to develop new tools and/or help a customer to become more productive.

The above and yet other objects and advantages of the present invention will become apparent from the hereinafter set forth Brief Description of the Drawings, Detailed Description of the Invention and Claims appended herewith

### BRIEF DESCRIPTION OF THE DRAWINGS

FIG. 1 is a generic example of an analog-digital-mixed chip design flow.

FIG. 2 is an elaboration of the flow schematic of FIG. 2 showing, in greater detail, the analog aspects thereof.

FIG. 3 is a menu used in the selection of modules that may comprise a system or flow process to be concurrently visualized.

FIG. 4 illustrates modules that have been selected for a given project simulation.

FIGS. 5A and 5B illustrate a specific respective digital and analog design flow based upon the process of FIG. 2.

FIG. 6A and 6B illustrate design flow of FIG. 5, however, integrating thereinto an analog-mixed signal (AMS) designer product.

FIG. 7 is an example simulation output process step of module 402 of FIGS. 5A and 6A.

FIG. 8 is an example simulation output of the entire process shown in FIGS. 6A and 6B.

FIG. 9 is an example simulation showing a result for a “best case” analysis of the system.

FIG. 10 indicates test bench settings for an analysis of the type of FIG. 9.

FIG. 11 is an example simulation showing a “worse case analysis” in which such parameters are used for the simulation of each relevant module.

FIG. 12 is an example of test bench setting for an analysis of the type of FIG. 11.

FIG. 13 is an example simulation result for an analysis in which concurrency is not exploited in an optimal fashion.

FIG. 14 shows test bench settings for an analysis of the type of FIG. 13.

FIG. 15 is a flow diagram showing the application of the present inventive method to management and personnel areas.

FIG. 16 is a diagram generalizing the principles of FIG. 15.

### DETAILED DESCRIPTION OF THE INVENTION

In one embodiment, the invention is implemented by capturing a chip design process in said hardware description language (HDL). The process flow is modeled as a combination of process actions, with each process action in the flow represented as one or more HDL modules. Each module, that represents a process step, includes information corresponding to real-world properties of that process step, e.g., operating parameters, inputs, outputs, and timing factors. Because modules such as Verilog can be analyzed for internal behaviors as well as interrelationships with other modules, implementing a process flow in Verilog inherently permits advanced management of behavior and performance for both the overall system as well as individual modules. Because Verilog is a concurrent language, multiple simultaneous and co-determinant events can be modeled and analyzed. Because this approach is modular, alternative process steps and process changes can be reviewed and analyzed to optimize choices of particular process steps and vendors.

Table 1 below maps various features of Verilog with corresponding concepts in chip design flow and project management. This list is merely illustrative of possible mappings:

TABLE 1
Mapping Verilog Features to Chip Design
Flow and Project Management:

| Verilog Feature | Possible Use |
|---|---|
| Concurrency | Various project stages |
| | that go on in parallel |
| Software and PLI | Reconfigure the design flow |
| | with mix and match |
| Events | Flags to ensure that all design |
| | and library files are in place |
| Stimulus | Set different completion and availability |
| | flags and determine what the project |
| | needs are and where the project delays |
| | are |
| Time Delays | Capture Project Delays, ramp-up in |
| | training, resource limitation, etc., |
| Random number generation | Build non-deterministic behavior in |
| | Project flow |
| Finite State Machine | Concept of hierarchical ability to |
| | descend to |
| | lower levels of design/tool detail |
| Flipflops | Memory - to stay in a given stage of |
| | design flow |
| | And save results |
| Gates | Gating to ensure satisfaction of |
| | appropriate conditions before a tool is |
| | invoked |
| Timing Analysis | Identify project delays |
| Documentation | Needed for communication. Critical |
| Parameter | Pass parameters at instantiation to |
| | customize the module's behavior |
| Module | Each domain expert can capture |
| | his/her expertise without undue |
| | concern about other tools. |

The following is a list of possible uses for a modeling tool implemented using a concurrent language:
A manager's overview document.
Mix and match to validate knowledge/articulate mixed vendor design flow.
Help CAD (computer-aided design) support groups track complete design flow.
Use table look-up/functions to capture learning curves
Use software, e.g., via a programmable logic interface (PLI) and/or virtual program interface (VPI), to specify a time schedule and trigger various models/modules
Use random number generator functions to assign non deterministic behavior to triggering various modules
Capture and model tool, infrastructure development delays as fixed or non-deterministic delays, or as functions of other variables
Identify training needs. Simulate the design flow as per the current infrastructure and staffing needs and see whether the deadlines will be met.
Use as documentation for communication across multiple disciplines. Hyperlink documents that expand on a topic.
Develop verification methodology.
Educate users of possible cross-disciplinary bridges, such as HDS (Block Wizard) to generate/link Verilog with SPW.

Other embodiments of the invention utilize the VHDL language to capture a process flow. An alternate approach for capturing/modeling a process flow may involve use of concurrent versions of the C or C++ languages (such as SystemC), or a derivative such as the Testbuilder product available from Cadence Design Systems of San Jose, Calif. Testbuilder supports multithreading and is built on C++, which is object oriented. Event and Delay control, and sequential and parallel blocks are also supported in Testbuilder. Many random number generation schemes feasible in this product. Stochastic Petrie nets can also be implemented. UML (unified modeling language) and concurrent C++ code generated from it may also be used to capture the process flow.

### EXAMPLE 1

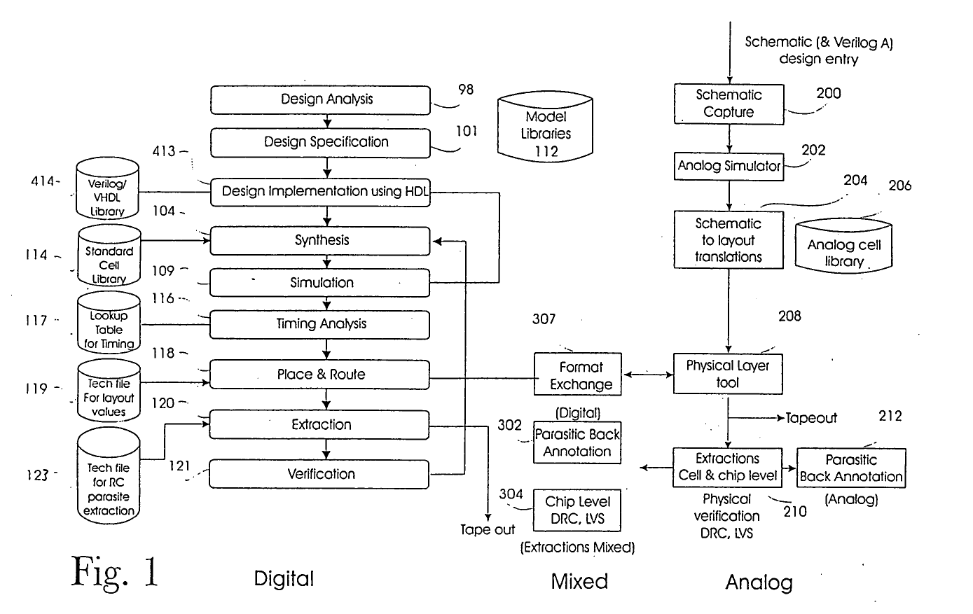

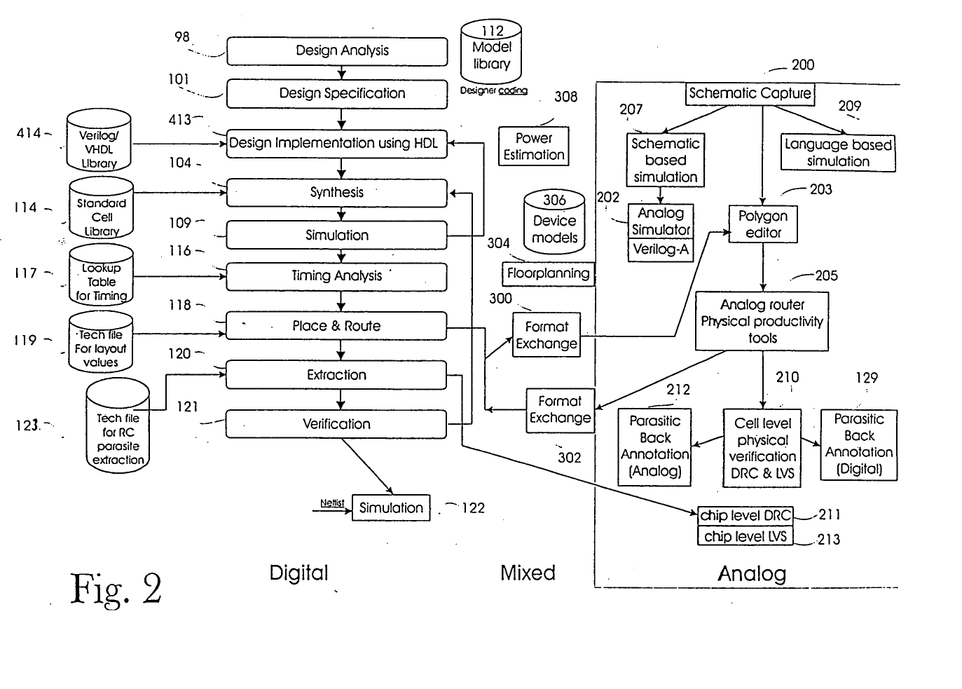

FIGS. 1 and 2 show generic examples of an analog-digital-mixed signal chip flow. These figures can be used to develop a detailed and highly specific design flow, e.g., a flowchart. At the left of each figure appears a standard digital design flow.

Therein Design Analysis 98 is a very crucial step in digital design. The design analysis is where the design functionality is stated. For example, if we are making a processor, the design analysis 98 will state the type of functionality that is expected.

Design specification (101) is a step at which the performance of the chip is stated in definite terms. For example, if we are making a processor, the data size, processor speed, special functions, power, etc. are clearly stated at this point. Also, the way to implement the design is somewhat decided at this point. Design specification deals with the architectural part of the design at highest level possible. Based upon this foundation, the whole design can be built.

Synthesis of HDL (104) Once the HDL code has been put through simulations, the simulated code is taken to synthesis to generate the logic circuit. Most the digital designs are built up of some basic elements or components such as gates, registers, counters, adders, subtractors, comparators, random access memory (RAM), read only memory (ROM), and the like etc. Synthesis forms the fundamentals of logic synthesis using electronic design automation (EDA) tools.

Simulation (109) using Hardware Description Language (HDL). HDL is used to run simulations. It is very expensive to build an entire chip and then verify the performance of the architecture. Chip design can take an entire year. If the chip does not perform as per the specifications, the associated costs in terms of time, effort, and expense would make such a project cost prohibitive. Hardware description languages provide a way to implement a design without going into much architecture, as well as a way to simulate and verify the design output and functionality. For example, rather than building a mix design in hardware, using HDL one can write Verilog code and verify the output at higher level of abstraction. Some examples of HDL are VHDL and Verilog HDL.

After the simulation, HDL code 413 is taken as input by the synthesis tool 104 and converted to a gate level simulation 109. At this stage the digital design becomes dependent on the fabrication process. At the end of this stage, a logic circuit is produced in terms of gates and memories.

Standard Cell Library (114) is a collection of building blocks, which comprises most of the digital designs that exist. The cell libraries are fabrication technology specific.

When the synthesis tool 104 encounters a specific construct in HDL, it attempts to replace it with a corresponding standard cell component from the library 114 to build the entire design. For example, a “for loop” could get converted to a counter and a combinational circuit.

Netlist 125. The output of synthesis is a gate level netlist. A Netlist is an ASCII file which enlists and indicates the devices and the interconnections between them. After the Netlist is generated as part of synthesis, the Netlist is simulated to verify the functionality of this gate level implementation of design. Prior to this level, only functionality is considered. Afterward, each step considers performance as well.

Timing Analysis (116) RTL and gate level simulations don't take into account the physical time delay in signal propagation from one device to another, or the physical time delay in signal propagation through the device. This time delay is dependent on the fabrication process adopted.

Each component in the standard cell library 114 is associated with some specific delay. Delay lookup tables 117 list delays associated with components. Delays are in the form of rise time, fall time and turn off time delays.

Most of the digital designs employ the concept of timing by using clocks, which makes the circuits synchronous. For example, in an AND gate with two inputs, x and y, If at time t=1 ns, x is available, and y comes 1 ns later, the output would be inaccurate. This mismatch in timing leads to erroneous performance of design.

In timing analysis (both static and dynamic) using said delay lookup tables 117, all the inputs and outputs of components are verified with timing introduced.

In this era of high performance electronics, timing is a top priority and designers spend increased effort addressing IC performance. Two Methods are employed for Timing Analysis: Dynamic Timing Analysis and Static Timing Analysis.

Dynamic Timing Analysis. Traditionally, a dynamic simulator has been used to verify the functionality and timing of an entire design or blocks within the design. Dynamic timing simulation requires vectors, a logic simulator and timing information. With this methodology, input vectors are used to exercise functional paths based on dynamic timing behaviors for the chip or block. The advent of larger designs and mammoth vector sets make dynamic simulation a serious bottleneck in design flows. Dynamic simulation has become more problematic because of the difficulty in creating comprehensive vectors with high levels of coverage. Time-to-market pressure, chip complexity, limitations in the speed and capacity of traditional simulators—all are motivating factors for migration towards static timing techniques.

Static Timing Analysis (STA) STA is an exhaustive method of analyzing, debugging and validating the timing performance of a design. First, a design is analyzed, then all possible paths are timed and checked against the requirements. Since STA is not based on functional vectors, it is typically very fast and can accommodate very large designs (multimillion gate designs).

STA is exhaustive in that every path in the design is checked for timing violations However, STA does not verify the functionality of a design. Also, certain design styles are not well suited for static approach. For example, dynamic simulation may be required for asynchronous parts of a design and certainly for any mixed-signal portions.

Place and Route (118) is the stage where the design is implemented s at semiconductor layout level. This stage requires more knowledge of semiconductor physics than digital design.

Semiconductor layout has to follow certain design rules to lay devices at the semiconductor level. These design rules are fabrication process dependent. The layout uses layers such as p/n diffusion, nwells, pwells, metals, via and iso. Rules involving minimum spacing, and electrical relation between two layers are known as design rules which are stored on database 119.

Placement and Routing 118 involve laying out the devices, placing them, and making interconnections between them, following the Design Rules. The result is the design implemented in the form of semiconductor layers

Parasitic Back Annotation (212) Once the layout is made, there are always parasitic capacitances and resistances associated with the design. This is because of the compact layouts to make the chips smaller. The more you compact the layout, the more will it introduce these parasitic components. The parasitic components interfere with the functioning and performance of the circuit in terms of timing, speed and power consumption.

Extraction (120) Due to the parasitic capacitances and resistances, it is important to extract these devices from the layout and check the design for performance and functionality. Therein extracts from the layout, the devices formed because of junctions of different semiconductor and metal layers and the interconnections. The extraction is supported by tech file 123.

Verification (121) is either a tape out-stage of the chip or a stage where design is again taken back through the same flow for optimization or modification. It verifies the extracted view of the chip for performance and functionality.

As may be noted a feedback loop exists between simulation 109 and HDL design implementation 413, as well as between verification 121 and synthesis 104.

On the analog side of FIGS. 1 and 2 is shown schematic capture 220 which flows into analog simulation 202, with Verilog 402 in support thereof.

This appears as schematic simulation 207 and language-based simulation 209. Analog cell library 206 is then employed to facilitate schematic-to-layout simulations 204 which flows to physical layout tool 208 which flows to analog extraction level 220 which flows to said analog parasitic back annotation 212. Also shown in FIGS. 1 and 2 are mixed elements including D/A format exchange 300, A/D format exchange 302, and floor planner 304. FIG. 2 further shows analog model library 306 and power estimator 308. FIG. 2 further indicates that schematic capture 200 flows to polygon editor 203 which flows to analog router 205 which flows to cell level verification 210. This in turn flows to analog and digital back annotations 212 and 224 respectively. Said D/A exchange 300 flows to editor 203, analog router 205 flows to A/D exchange 302, and digital extraction 120 flows to chip level DRC and LVS 211 and 213 respectively.

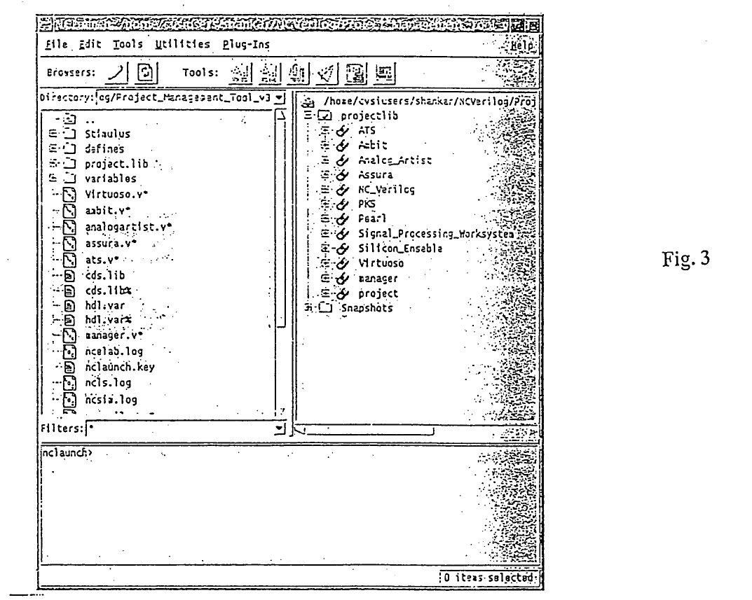

FIG. 3 illustrates a menu for selection of modules that may comprise a system to be concurrently visualized.

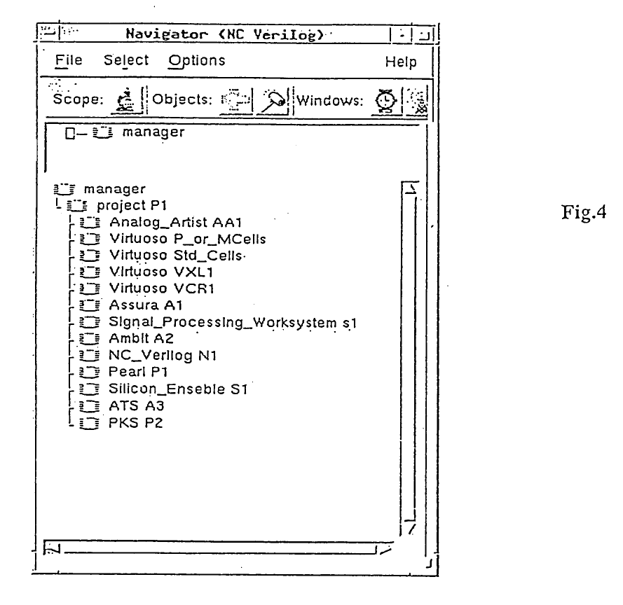

FIG. 4 illustrates modules that have been selected for a project simulation.

### EXAMPLE 2

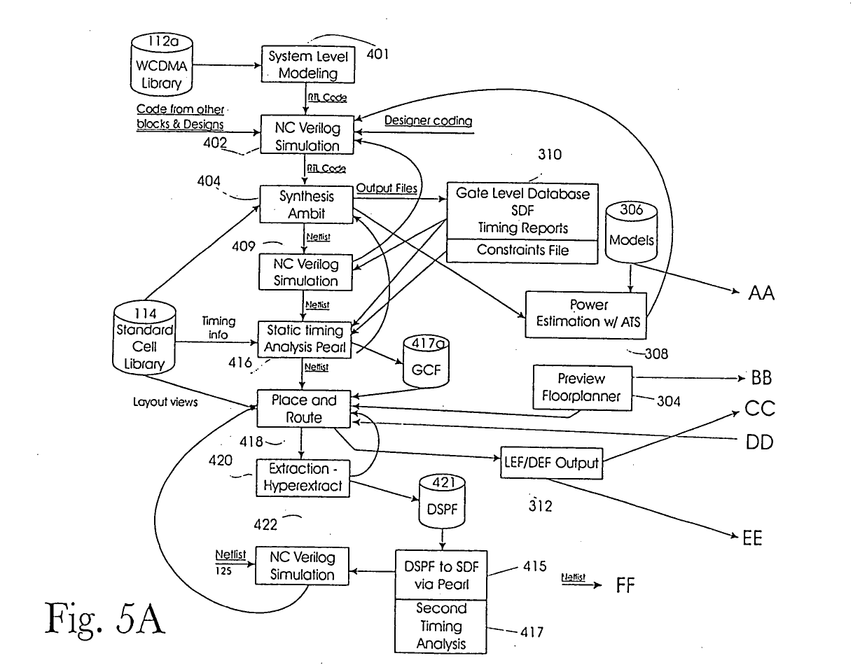

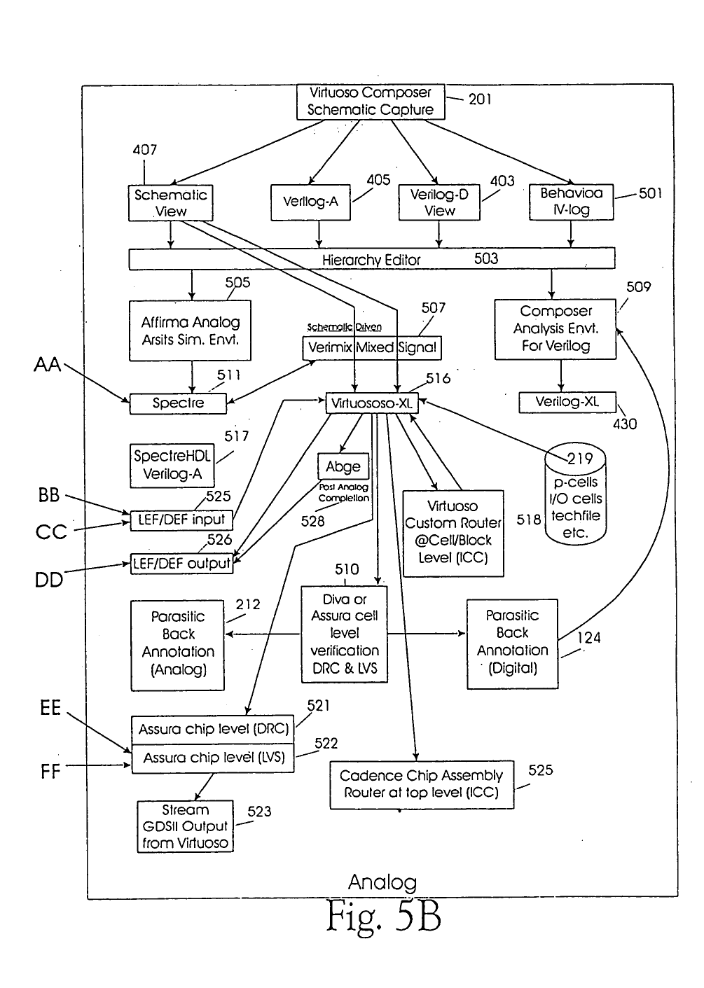

FIGS. 5A and 5B illustrate a detailed and specific design flow based upon the process of FIGS. 1 and 2.

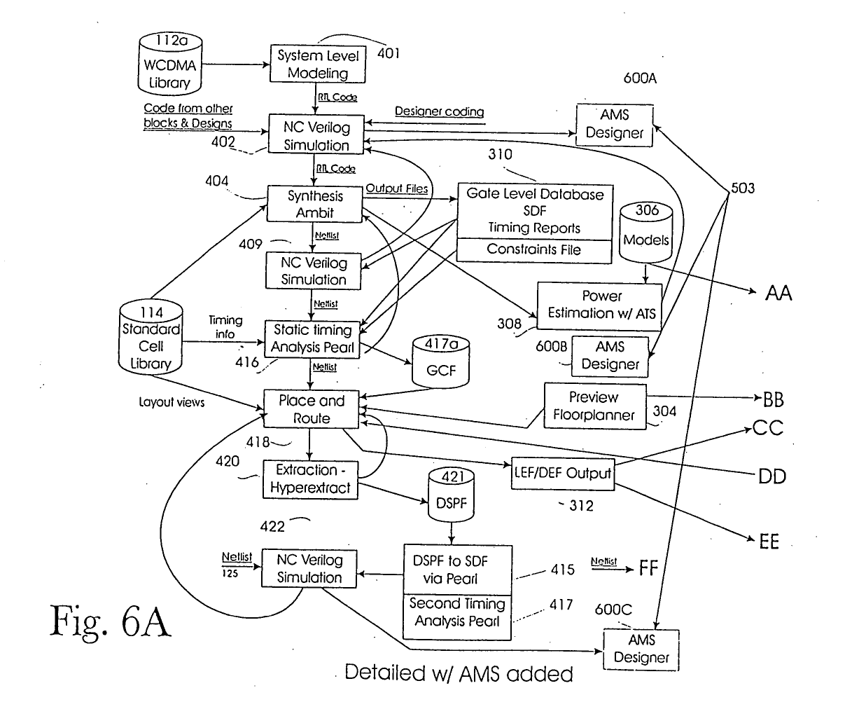

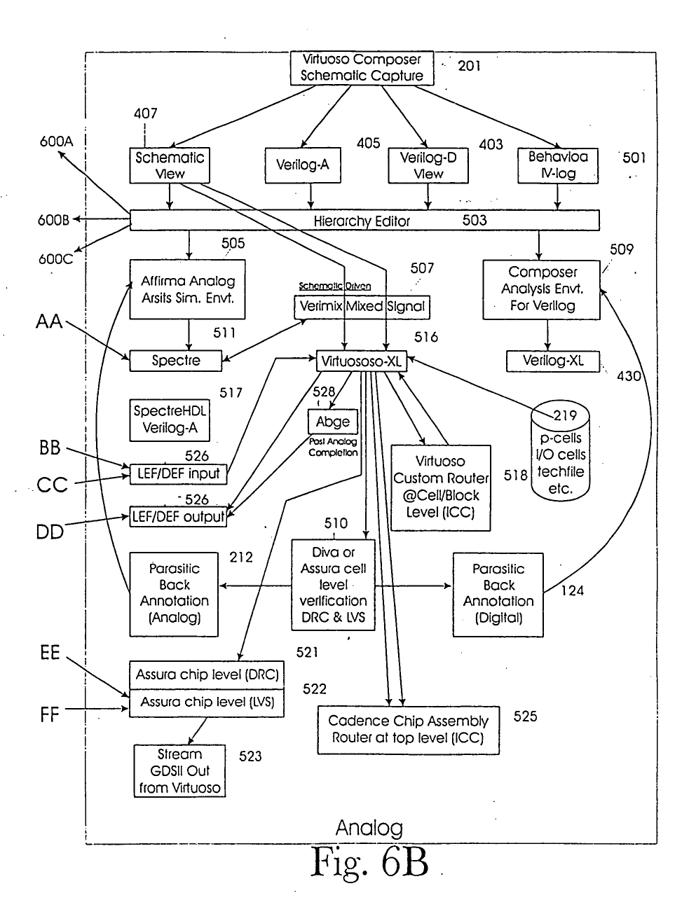

FIGS. 6A and 6B illustrate a the design flow of FIG. 5 that incorporates an analog-mixed-signal (AMS) designer product. FIGS. 5A and 6A follow the same digital design flow, but in Verilog, above described in reference to FIGS. 1 and 2 Similarly, FIGS. 5B and 6B follow the analog design flow above referenced FIGS. 1 and 2, but in Verilog HDL.

That is, shown in FIG. 5A is system level modeling step 401 which draws upon WDCMA library 112a. The output thereof employs RTL code and thereby provides an input to NC Verilog simulation 402 (more fully described below.) Into this block also flows code from other blocks and designs as well as feedbacks from serial digital and mixed A/D steps (described below). The output of said step 402 employs RTL code to provide an input to synthesis ambit 404 which draws Verilog descriptions from said standard cell library 114.

This output of ambit 404 employs Netlist (above described) to provide input to NC Verilog simulation 409. This in turn employs Netlist to flow into static timing analysis pearl 416. An output thereof is provided to a GCF database 417a and, through Netlist, to place and route step 418, the output of which flows into extraction-hyperextract step 420, the output of which flows into DSPF database 421 and also feeds back to place and route step 418. DSPF database then flows into a second timing analysis 417, which includes DSPS-to-SDF via Pearl. Said block step in turn flows into NC Verilog simulation 422 which also receives input from Netlist 125. The output of simulation 422 feeds back into said place and route step 418.

With further reference to FIG. 5A, the “mixed portion” to the right of said view, shows gate level database SDF timing reports 310 which includes a constraint file. Reports 310 receive an input from synthesis ambit 404 and provide outputs to Verilog simulation 409 and static timing analysis pearl 416.

A power estimation step 308 is supported by inputs from synthesis ambit 404 and mixed models 306. A preview floorplanner 304 supports said place and route step 418 which itself provides an input to LEF/DEF output 312. Therefore, salient outputs of the mixed portion of the detailed design flow of FIG. 5A are AA from models 306, CC and EE from LEF/DEF output 312, and FF Netlist output shown to the lower right of FIG. 5A.

With reference to FIG. 5B which shows the analog side of the Verilog detailed design flow, place and route 418 receives input DD from analog LEF/DEF output 526 (see FIG. 5B). As may be further noted therein, Spectre module 511 receives input AA from models 306, LEF/DEF input 525 receives input BB from floor planner 304 and receives input CC from mixed LEF/DEF output 312 shown in FIG. 5A. Assura chip levels 521 and 522 receive an input EE from LEF/DEF output FIG. 5A and input FF of the Netlist also shown in FIG. 5A.

At a more global level, FIG. 5B shows the detailed analog design flow associated with state of the art chip design. This begins with a Virtuoso composer schematic capture 201 which provides inputs to Verilog D tool 403, Verilog-A tool 405, a schematic step 407, and a behavioral log 501. The output of each of these steps are provided to a hierarchy editor 503. Schematic step 407 also provides inputs to Vertuoso-XL 516 after passing through Verimix mixed signal layer 507. With further regard to hierarchy editor 503, the same provides inputs to Affirma Analog Artist simulation 505 and to Composer analysis Verilog 509. With regard to the left side of FIG. 5B, Affirma analog simulation 505 may be seen to flow into said Spectre tool 511 which itself communicates bi-directionally with said Verimex mixed signal layer 507. Said LEF/DEF input 526 supports Virtuoso-XL 516 which provides input to said LEF/DEF output 527. Virtuoso-XL also provides an input to post analog completion step ABGE 528. Said Virtuoso-XL 516 further provides input to said Assura chip levels 521 and 522 and to a Cadence chip assembly router 525. Said assured chip level 522 provides input to stream GDSI output 523. Virtuoso-XL516 also provides input to a Diva or Assura cell level verification 510 which in turn provides inputs to analog and digital parasitic back annotations 212 and 124 respectively. Therein, annotation 212 provides feedback to Affirma analogy simulation 505, and digital back annotation 124 provides feedback to Verilog Composer analysis tool 509, which itself provides inputs to Verilog 430. As may be noted, said Cadence chip assembly router 515 also provides feedback to XL 516. Further input is provided to XL 516 by p-cell database 219, shown to the right of FIG. 5B. finally, there is shown a continuous feedback loop between Virtuoso custom router 518 and said Virtuoso XL 516.

As above noted, FIGS. 6A and 6B closely follow said FIGS. 5A and 5B respectively, the sole difference therebetween being the addition of the AMS designer tool 600 which is shown at three points to the right of FIG. 6A. More particularly, AMS designer 600A receives inputs from NC Verilog simulation 402 and hierarchy editor 503. AMS designer 600B receives inputs from NC Verilog simulation 409 and from said hierarchy editor 503 of the analog part of the system. A MS designer 600C receives inputs from NC Verilog simulation 422 as well as from said hierarchy editor. In all other respects, the detailed design flow of FIG. 6 functions in the same manner as that described above with respect to FIG. 5.

To create this type of design flow, one approach is to interview various designers to understand their design flows and update them with existing equivalent or better tools. However, a detailed flow chart for a complex process (e.g., the process of FIG. 5) often lacks clarity, with many confusing “go to's.” Because of this complexity, updating is very difficult and exploration of different options and their impact on project management is not reasonably feasible.

According to this example, the process flow of FIG. 5 can be described and represented in a modularized manner. In this approach, each process step is represented using a module that includes detailed information about the operation and parameters of that process step.

For example, the NC Verilog Simulation step is shown in FIG. 5A (marked as block 402). Process block 402 represents a stage in the chip design process in which RTL code undergoes simulation/verification using the NC-Verilog product. In this embodiment, each vendor of a product that is considered to implement a particular process step provides its own module that describes the appropriate modeling information for that product. Thus, the vendor of the NC-Verilog product would provide such a module that would be used to represent step 402 in FIG. 5. If another vendor's product is considered for use in implementing step 402, then the module associated with that vendor's product is used instead.

The following is example of Verilog code that can be used to implement the NC-Verilog product used for process step 402:

NC_Verilog (NCVerilog_Done, NCVerilog_Continuing, NCVerilog_Design_In, NCVerilog_Library, NCVerilog_Env, NCVerilog_Start);

```
    \grave{ }include “./variables/global variables.v”
    \grave{ }include “./defines/ncverilog define.v”
```

| | //=== Declare the outputs | |
|---|---|---|
| output | NCVerilog_Continuing, NCVerilog_Done; | |
| | //=== Declare the inputs | |
| input | [1:0] NCVerilog_Design_In, | |
| | NCVerilog_Env; | |
| input | NCVerilog_Library, | |
| | NCVerilog_Start; | |
| | //=== Declare the internal variables | |
| reg | Simulation_Snapshot, | |
| | NCVerilog_Output_Log, | |
| | NCVerilog_Continuing, | |
| | NCVerilog_Done; | |
| integer | Size_Time_Factor, | |
| | User_Time_Factor, | |
| | Completion_Time; | |
| | //=== Leave this unchanged, just change the | |
| | parameters according to the tool | |
| parameter | Design_Size | = \grave{ }Medium; |
| parameter | User_Experience | = \grave{ }Average; |
| parameter | OS_Version | = 2.8; |
| parameter | Memory_Space_Available | = 5e9; |
| parameter | NCVerilog_Version | = 3.3; |
| parameter | Swap_Space | = 1e9; |

| | |
|---|---|
| | //=== Setting the initial values to the variables |
| initial | |
| begin | |
| | Size_Time_Factor = 10; |
| | User_Time_Factor = 20; |

Completion_Time = Design_Size * Size_Time_Facto+ User_Experience *
User_Time_Factor;

| | |
|---|---|
| | Simulation Snapshot = 0 ; NCVerilog_Continuing= 0 ; |
| | NCVerilog_Output_Log = 0; |
| | NCVerilog_Done = 0; |
| end | |
| | //=== Procedure of relating input and the output |

```
    always @(NCVerilog_Env or NCVerilog_Design_In or NCVerilog_Library or
    NCVerilog_Start)
      begin
```

| | |
|---|---|
| | #1 |
| | if (NCVerilog_Start) |
| | begin |
| | if (! \grave{ }is_NCVerilog_cds_lib) |
| | $display(“cds.lib file is not Available. |
| | Incomplete |
| Environment!!!”); | |
| | if (!\grave{ }is_NCVerilog_hdl_var) |
| | $display(“hdl.var file is not Available. Incomplete |
| Environment!!!”); | |

(!(\grave{ }is_NCVerilog_design_verilog∥\grave{ }is_NCVerilog_design_vhdl))

| | |
|---|---|
| | $display(“Only Verilog or VHDL description should |
| | be used. |
| Check the format...”); | |
| | if (!NCVerilog_Library) |
| | $display(“Library required for the design |
| | unavailable...”); |
| | //=== To be upgraded with the version |
| | compatibily table for |

Hardware, OS and simulator Version.

| | If (OS_Version<2.8) | |
|---|---|---|
| | $display(“Unsupported OS....Upgrade you | |
| | OS to version %f or | |
| higher”,2.8); | | |
| | if (NCVerilog_Version<3.3) | |
| | $display(“Incompatible LDV | |
| | version..Upgrade to %f or | |
| higher”,3.3); | | |
| | if (NCVerilog_Design_In && NCVerilog_Env==2′b11 | |
| && NCVerilog_Library) | | |
| | begin | |
| | NCVerilog_Continuing = 1; | |
| | #Completion_Time | |
| | Simulation_Snapshot | = 1; |
| | NCVerilog_Output_Log = 1; | |
| | NCVerilog_Continuing = 0; | |
| | NCVerilog_Done | = 1 |
| | end | |
| | #1 | |
| | NCVerilog_Done = 0; | |
| | end | |
| end | | |
| endmodule | | |

The following is an example for a “./variables/global variables.v” file of variables employed in the above module:

| | |
|---|---|
| | //=== Output variables |
| wire | NCVerilog_Continuing, |
| | NCVerilog_Done; |
| | //=== Inputs |
| reg [1:0] | NCVerilog_Design_In |
| | NCVerilog_Env; |
| reg | NCVerilog_Library; |
| initial | |
| begin | |

| | |
|---|---|
| NCVerilog_Design_In | = 0; |
| NCVerilog_Env = 0; | |
| NCVerilog_Library | = 0; |
| end | |

\grave{ }include “./defines/ncverilog_define.v”

The following is an example for a “./defines/ncverilog_define.v” file of definitions employed with the above module:

| | |
|---|---|
| \grave{ }define is_NCVerilog_cds_lib | NCVerilog_Env[0] |
| \grave{ }define is_NCVerilog_hdl_var | NCVerilog_Env[1] |
| \grave{ }define is_NCVerilog_design_verilog | NCVerilog_Design_In[0] |
| \grave{ }define is_NCVerilog_design_vhdl | NCVerilog_Design_In[1] |
| \grave{ }define is_NCVerilog_Library | NCVerilog_Library |

The following is an example of test stimulus that can be applied to the above module:

| | |
|---|---|
| module | ProjectManager; |
| \grave{ }include | “z:/nc-verilog/Global_Variables.v” |
| \grave{ }include | “z:/nc-verilog/NCVerilog_Variables.v” |

| | |
|---|---|
| NC Verilog N1 | (NCVerilog_Done, |
| | NCVerilog_Continuing, |
| | NCVerilog_Design_In, |
| | NCVerilog_Library, |
| | NCVerilog_Env, |
| | NCVerilog_Start); |
| initial | |
| begin | |

| | | |
|---|---|---|
| | \grave{ }NCVerilog_is_Cds_Lib | = \grave{ }yes; //== Checks for cds.lib |
| | \grave{ }NCVerilog_is_Hdl_Var | = \grave{ }yes; //== Checks for hdl.var |
| | \grave{ }NCVerilog_is_Verilog | = \grave{ }yes; //== Source in Verilog? |
| | \grave{ }NCVerilog_is_Vhdl | = \grave{ }yes; //== Source in |
| VHDL? | | |
| | NCVerilog_Library | = \grave{ }yes; //== required library |
| present | | |
| | NCVerilog_Start | = \grave{ }yes; //== Start NCV |

simulation
end
endmodule

The following is an example of global variables that can be applied to the above module:

| | |
|---|---|
| \grave{ }define available | 1′b1 |
| \grave{ }define unavailable | 1′b0 |
| \grave{ }define Small | 1 // Design Size |
| \grave{ }define Medium2 | |
| \grave{ }define Large | 3 |
| \grave{ }define Beginner | 3 // User Skill Level |
| \grave{ }define Average | 2 |
| \grave{ }define Expert | 1 |
| integer yes, no; | |
| initial | |
| begin | |
| yes=1; | |
| no=0; | |
| end | |

The above module shows examples of the types of information that can be included for each product, such as inputs, outputs, performance or operating parameters, and timing factors. In addition, it is noted that parameters are included to customize the module for the particular situation or needs of an organization, e.g., the “design size” and “user experience” variables.

Such parameters can be filled-in and modified to match an organization's existing resources. The code can be compiled and analyzed to determine its performance, both individually and with respect to the overall process.

Similar parameters and variables exist for every module shown in the menus of FIGS. 3-4.

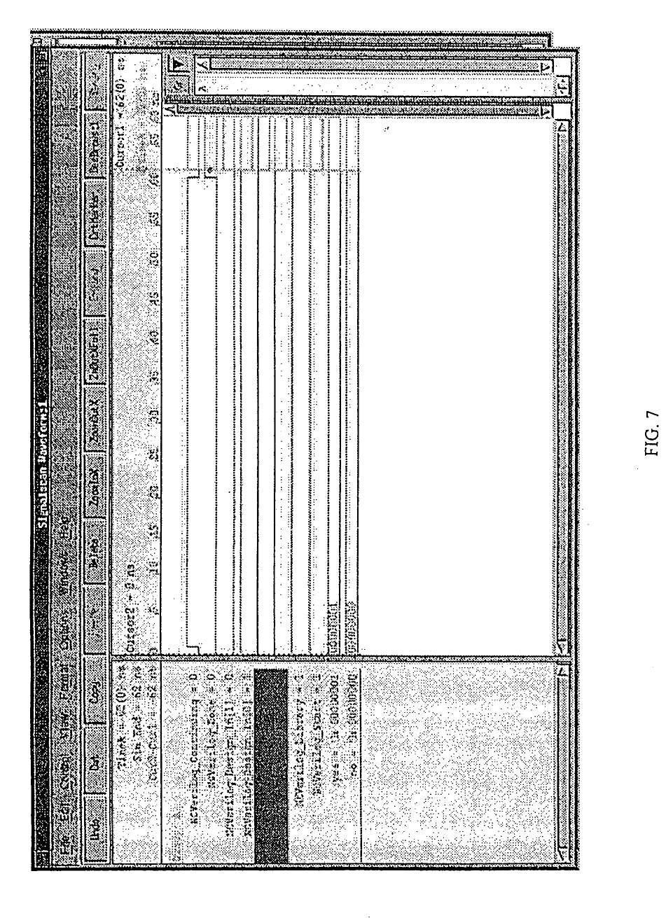

FIG. 7 therefore is an example simulation output for the module shown above, and shows the timing behavior of process step 402 in FIG. 5 if the NC-Verilog product is used.

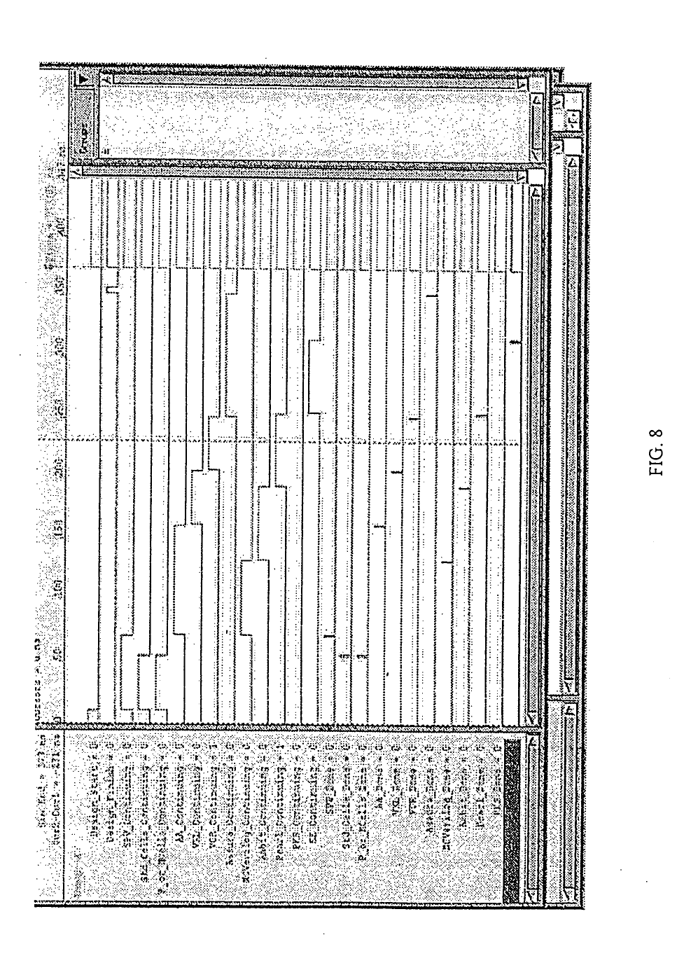

In this manner, the exact behavior of a particular module/product is known and can be used to analyze its operation and effect, both on an individual basis and with respect to the overall process, because its effect upon the entire process can be analyzed with respect to similar information that is collected for all other modules in the process flow by compiling and analyzing the code for all the modules in the overall process or system. By performing this type of analysis for process steps in the process, i.e., for relevant modules for each step in the process, the overall performance of the process can be determined. FIG. 8 shows an example simulation output for the entire process shown in FIG. 6, with timing signal analysis of not just the individual process steps in the process, but also the overall process as well (“design_start” and “design_end”), thereby showing in a visual manner the timing of all concurrent process steps, and any bottlenecks therein.

This approach allows ease of analysis of “what if” scenarios involving multiple products. If the process manager wishes to analyze whether another product can be used instead of the NC-Verilog product at process step 402, he merely substitutes the appropriate module for the other product in place of the above module for product. A similar compilation and analysis process is followed to determine if using the other product will improve or worsen the overall performance of the process.

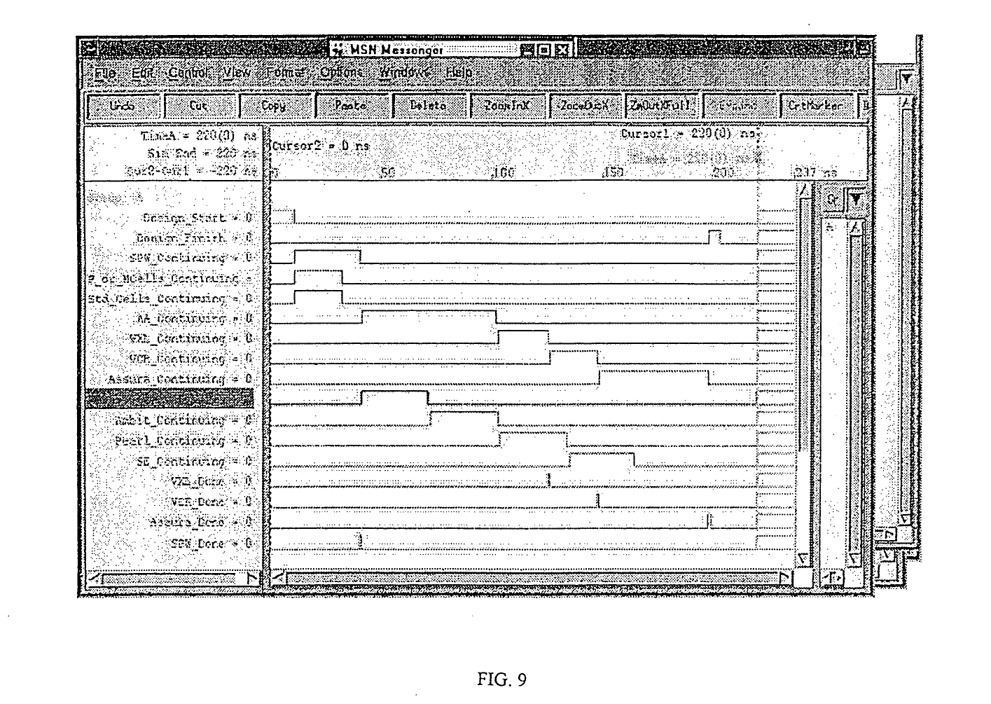

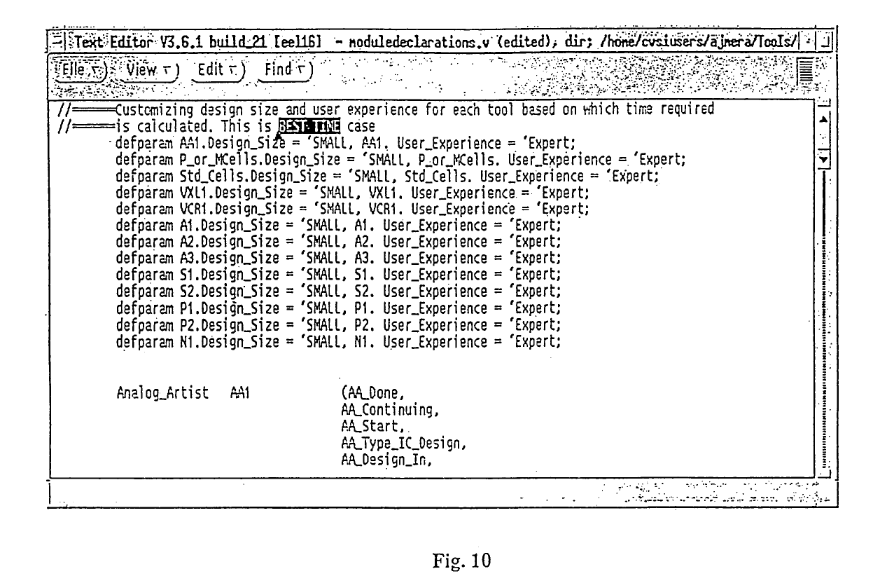

Other types of “what if” scenarios can also be analyzed using the invention. FIG. 9 shows an example simulation that results for a “best case” analysis, in which best case parameters are used for the simulation for each relevant module. Test bench settings for this type of best case analysis are shown in FIG. 10. Note that this type of best case analysis can be performed for each module, particular combinations of modules or for the overall system.

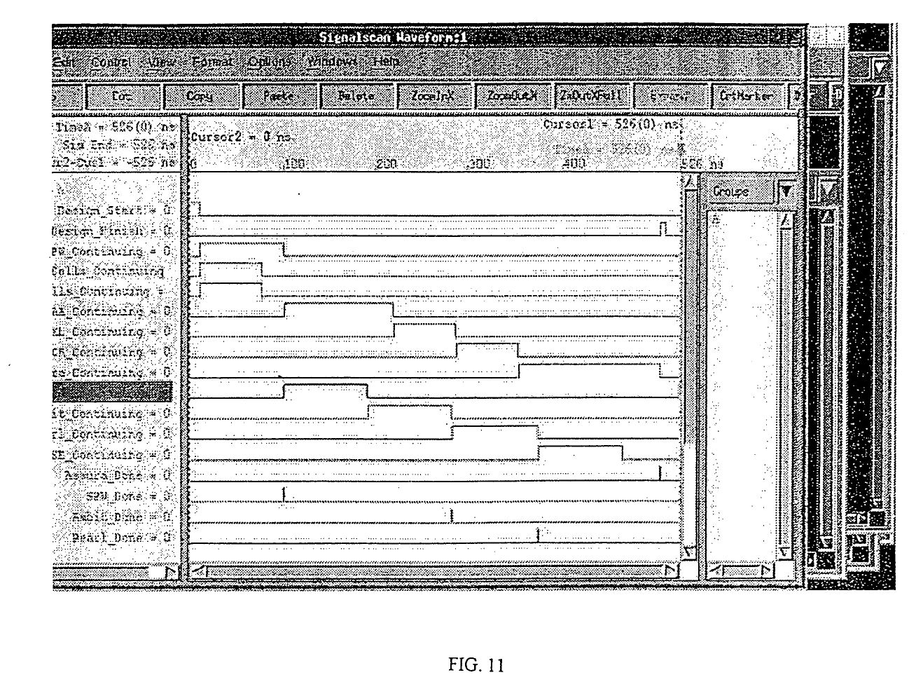

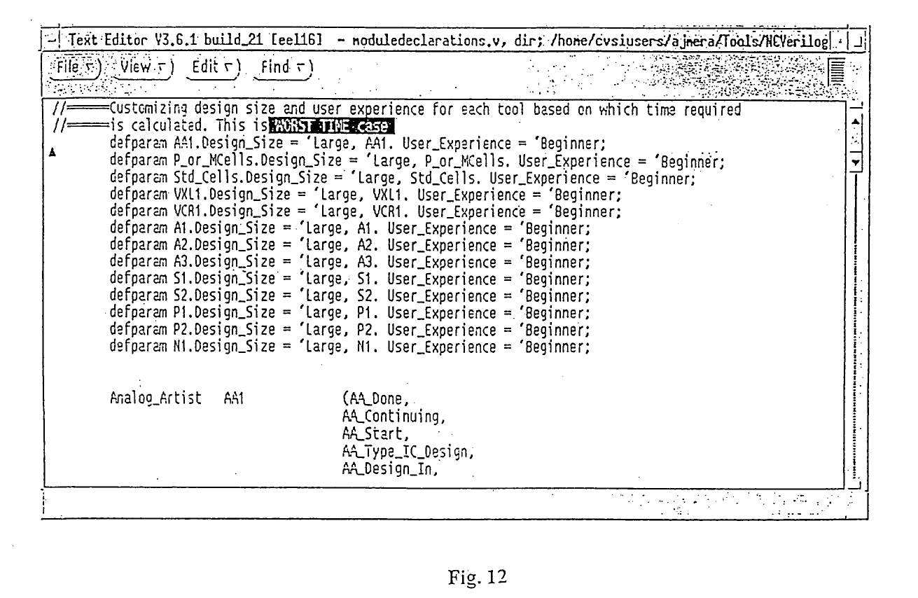

FIG. 11 shows an example simulation result for a “worst case” analysis, in which worst case parameters are used for the simulation for each relevant module. Examples of test bench settings for this type of analysis is shown in FIG. 12.

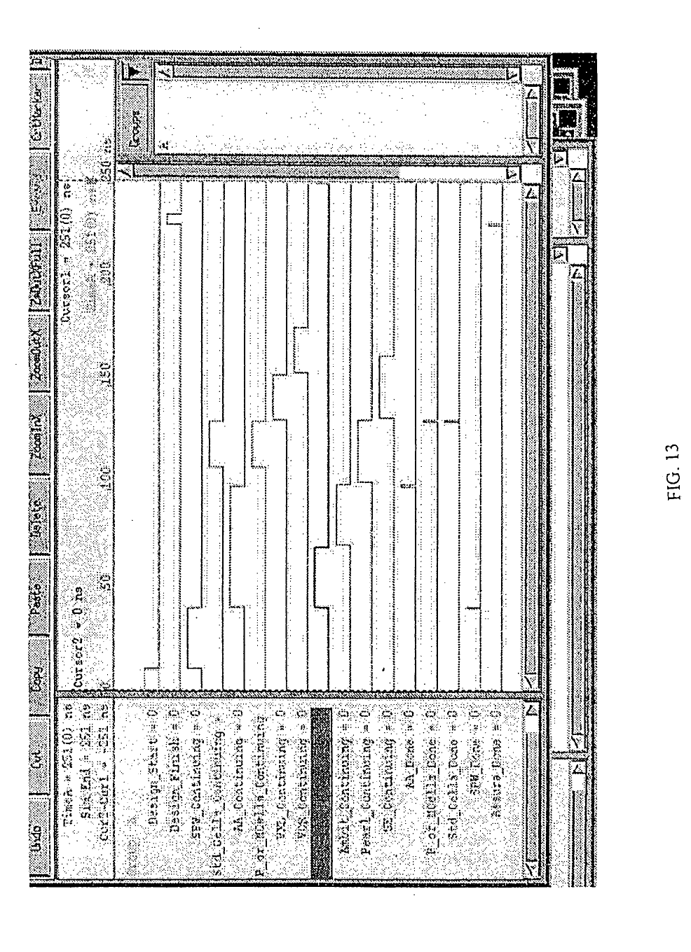

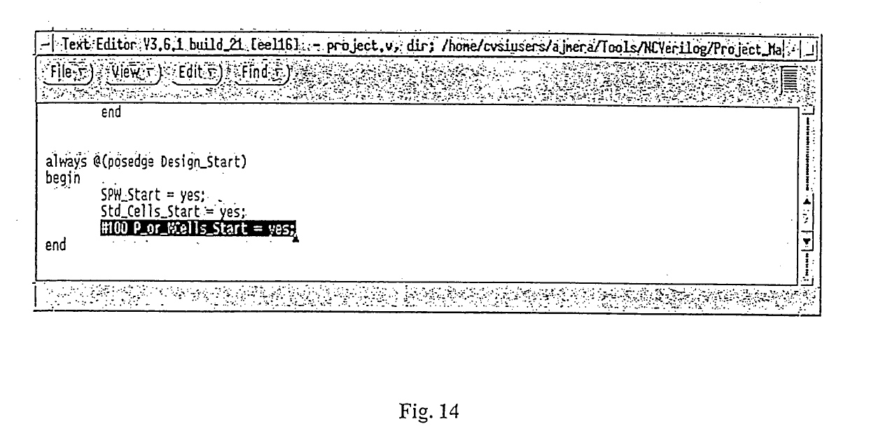

FIG. 13 shows an example simulation result for an analysis in which timing parameters are adjusted such that concurrency is not exploited well. As previously noted, one advantage of the present embodiment of the invention is the ability to analyze concurrency in a process flow. Verilog can be used to allow analysis of concurrent process stages. An example of test bench settings for this type of analysis is shown in FIG. 14. Note that “#100” indicates a delay value that is applied to the “P_or_Mcells_Start” parameter.

### EXAMPLE 3

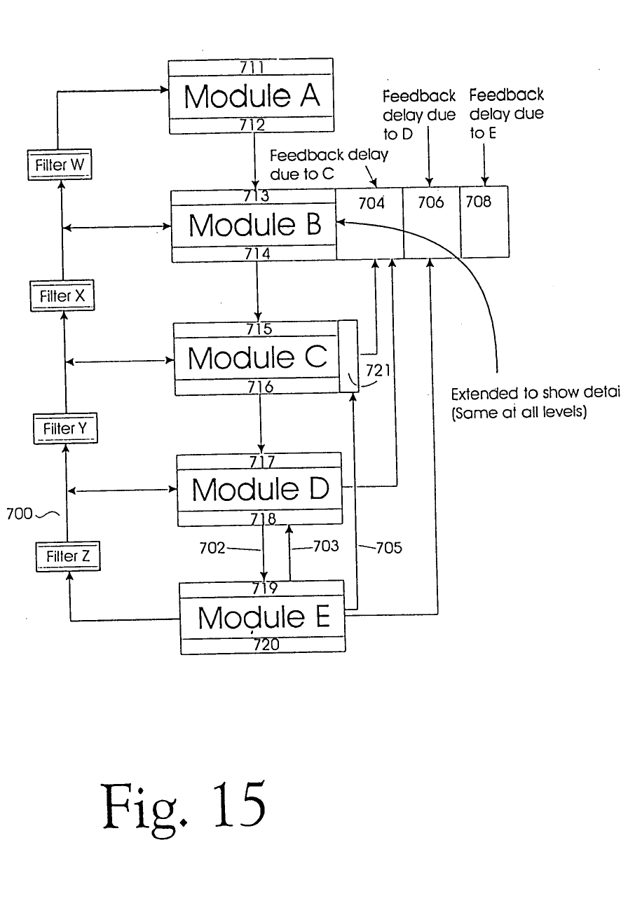

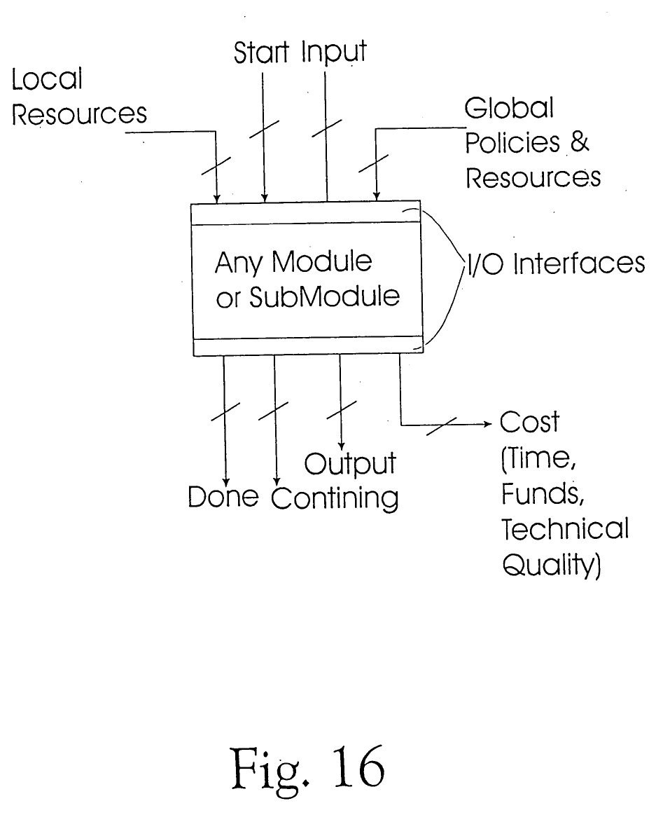

With reference to FIGS. 15-16, modules A, B, C, D, and E represent different phases or people in a typical product development cycle. This may be viewed as a way to introduce new features (software/hardware or accessories) in an existing system. For example, A may be a features expert who provides his output in one format (e.g., MS Word document format) while B, a product expert, reviews the requested additional features against the current product for feasibility. He, however, needs a different format of the file (e.g., a C+ language program) to rapidly complete his work, but has to accept the format of A. B will communicate with A, either by phone or another means (such as pseudocode or a standard questionnaire) and determine the actual changes suggested by A and negotiate a set that can be implemented. B then will communicate with C, the developer, who may want the input in another format, such as a hardware description language, but B can only provide the input in C+ language format. Or, perhaps, B will provide the input in an ambiguous manner, as with English, that can be misinterpreted. C discusses the issues with B, and implements the product increment. This may or may not take longer than other steps. D, is the checker, who may check that standards have been followed, that the prototype developed by C functionally meets the requirements output by A. E is the final system tester, who will generate stress tests on odd things that a customer could do. Usually, these are situations such as pressing two keys together, or doing something out of sequence (with respect to what the product's standardized flow implementation is. This may be: press key 1, then key 5. But the customer may press keys 1 and 5 faster or almost together (or as 5-1, by mistake) which takes the product to some unknown state. The system will either hang up or lead to some unknown behavior, not the expected behavior. This report is then used by C to improve the product. Eventually, the number of errors generated by E is reduced substantially, below a threshold, and the product is approved for the new set of incremental features. Of course, there may be other combinations that the group did not think about, which will come later as customer complaints and demands (the latter will result in another upgrade).

Further shown in FIG. 15 are input interfaces 711, 713, 715, 717 and 719 to said Modules A, B, C, D and E respectively, as well as output interfaces 712, 714, 716, 718 and 720 respectively. Said interfaces may be viewed as a localized intelligence of each module, which includes module operating and resource requirements and specific options. FIG. 15 also shows that communications of module interfaces may be either or both serially downstream 702 and serially upstream 703. Where a communication 705 occurs between non-series modules, e.g., E to C, a parallel interface 721 to the inputted module is necessary.

Therefore, at a lower level, the inventive method optimizes the series relationships, as in 712 to 713, 714 to 715, 716 to 715, and so forth, by O/I helping to match the protocols or “languages” thereof. At a higher level, many series and parallel I/O and O/I relationships may be concurrently visualized, as is shown in FIGS. 7, 8, 9 and 13, as described in Example 2 above. The significance of the “inputs” and “outputs” that may be visualized is more fully set forth below.

Further shown in FIG. 15 are Filters W, X, Y and Z that may optionally be used with outputs of modules B, C, D, and E respectively. Said filters may be thought of as serial and parallel executive summaries from lower to higher levels. Therefore, upward feedback 700 reflects feedback from lower to higher level modules, which is slower than downward communications 702 because of the time needed for management responses. Further shown are feedback delays 704, 706 and 708 associated with due to Modules C, D, and E respectively.

As may be noted in FIG. 16, a generic expression for each of the above steps would be as follows:

There are four possible types of inputs (each of which can be a vector, that is more than one signal):

“Start” and/or “Input”—Data formats the data obtained, one for each type. For each, there are different costs/delays associated with it;

“Local Resources and Constraints”—Experience of the group—that is the learning experience; expertise in the methodology of that step; number of available people; number of other projects simultaneously going on; and personal reasons; and

“Global Policies and Constraints”—Does the user company follow ISO or other industry standard formats, equipment, budget, tools, bonus structure, and design size and complexity?

All the local and global constraints may be used in an algebraic expression, based on the experience of the group manager for that step of the process, to determine the time delay for the step, and based on that, determine the cost for carrying out that step.

As an example,

| Expertise | Funds | Time | Comment |
|---|---|---|---|
| 0.3 | $30K | 3 weeks | New hire |
| 0.7 | $50K | 1 wk | 1-5 years |
| 1.0 | $200K | 1 day | 5+ years |

Intrapolate (possibly linearly) for in-between values.

“Comment” refers to their experience and expertise level. The same new hire, after 3 years, may gain enough experience, though of the same level of expertise, so he can become more efficient. These will be qualitative inputs given to the process modelers by the group managers.

The outputs are:

Status signals of “Done” and “Continuing”;
“Output”(formats that the process will provide, such as a prototype, document and test results, only in terms of their format); and
a “Cost” (proportional to time delay through the process stage and the funds consumed. Perhaps we can lump together for easy visualization.

One can show the results in three dimensions (product completion versus time and funds). One can include technical optimization as an additional parameter of this ‘cost’ output. These may include items such power dissipation, mobility, performance (speed, standards requirements), and quality (such as TQM).

Note that time and funds tracking makes it a communication and project management tool. Inclusion of technical issues may extend it to project optimization (first, the manager can do it with ‘what-if’ scenarios, and later one can incorporate certain digital design methods to do automatic optimization). Eventually, this can tie with process flow management tools (such as used in assembly line or chip design) to provide a powerful abstraction to implementation tool.

Note that each of the input and output types can be a vector. Thus, module B may accept input formats I, II, and III. And there will be a time penalty or time consumption, based on each format, that is different. Such information can be captured from talking to the managers. Another issue is that there are typically several projects going on, with several people, all at the same stage or process. As such, many ‘Start's, ‘Continue's, and ‘Done's may be needed. These will relate to many people and other resources within a stage.

Another issue is that there is always feedback from the lower to higher levels. This process my be discouraged because of many reasons: no standard formats and higher level managers abstract and distill the information going upwards. For example, test people may know something two years before one higher learns it only when an error or omission hurts product sales. This would occur because lower level people did not or could not inform the higher ones.

Also, each module A, B, C, etc., may have several underlying processes (such as A.1, A.2, A.3; B.1, B.2, B.3). such as a fractal which repeats itself from macro-to-micro levels.

Through the above, the applications above set forth in the Background of the Invention may be achieved. FIGS. 15-16 (Example 3) therefore reflects the preferred embodiment of the invention.

The present invention thereby allows global analysis of a process, regardless of the process' complexity. In a scenario in which multiple regionally separated business units are implementing a global process flow, s each particular business unit is responsible for one or more steps in the global process flow, and has to make business decisions that not only affect its own individual performance numbers, but possibly the overall process as well. Now multiply this type of decision-making scenario across all other business units involved in the process flow. For a very complex process flow involving many interdependent organizations and interlocking process steps, determining specific allocations of resources using conventional tools would be extremely difficult and probably inaccurate. Because existing tools cannot effectively perform this type of analysis on a global basis, it is likely that each local business unit would allocate its resources to optimize performance only on a local level. However, optimization may cause worsened performance on a global level.

### EXAMPLE 4

In an individual business unit that is performing two separate steps in a global process flow, and in which decisions about its allocation of resources will affect the timing of each process step, i.e., the more local resources allocated to one process step, the less is available for the other process step. If this business unit's process steps are interrelated to other process steps performed by remote other business units, its choice of resource allocation, and therefore time for completing each process step, will also affect the performance of other process steps and therefore the overall process. If one of the process steps performed by the local business unit is a greater bottleneck than the other process step, then global optimization may call for more resources to be applied to that bottleneck process step, and less resources to the other process step. However, without realizing that one of the process steps is a greater bottleneck to the overall process, local optimization may call for equal division of resources for each process step.

With the invention, analysis can be performed to optimize each step of the process, either on a local basis or for the performance of the overall process. This occurs in the present invention because the Verilog code for each process step can be analyzed by itself, or in combination with all other modules that make up the global process flow. In this manner, timing and performance analysis can be performed that identifies conditions to optimize performance for the overall process.

### EXAMPLE 5

In a situation in which a local business unit has an overcapacity of resources, to improve local efficiency the business unit may use all its available resources to produce a product. Therein, it is possible that the local business unit will overproduce, causing reduced efficiency e.g., managing excessive inventory buildup, for the overall process. By analyzing the process on a global basis, the allocation of resources can be adjusted to optimize global process performance, even though local performance is nominally affected.

### EXAMPLE 6

The invention can also be used to “synthesize” a project/resource plan to implement a process flow. In a process flow having a given parameters, a database can be provided having concurrent language modules and parameters for all resources available to be used for the process flow. The database may include, for example, information about products that can be acquired or are available to be used to implement process steps, personnel that are available, physical devices and facilities that can be acquired or are available. Information about personnel may include, for example, salary, experience, expertise, skills, and availability. Information about products may include, for example, performance and timing figures, cost, and availability.

This type of information in a database can be accessed and matched against specific process steps in the process flow. Performance analysis, e.g., as illustrated by FIGS. 8-14, can be employed to identify possible combinations of acceptable resources to implement the process. Analysis may be performed to determine combinations of resources that maximize various performance measures. For example, analysis may be performed to identify combinations that provides the best absolute performance in terms of timing, cost, product quality, etc. Guidelines may be provided to prioritize the performance factors when looking at various combinations of resources. The output of this synthesis/optimization and timing analysis process is a process/resource plan that can be used to implement the process flow within acceptable performance parameters. The above may be implemented through the use of a simple expression that expresses module completion time as a weighted linear addition of two terms only: designer experience and design complexity. In general, one would use a regression equation to capture the manager's feedback, i.e. a module manager.

While there has been shown and described the preferred embodiment of the instant invention it is to be appreciated that the invention may be embodied otherwise than is herein specifically shown and described and that, within said embodiment, certain changes may be made in the form and arrangement of the parts without departing from the underlying ideas or principles of this invention as set forth in the Claims appended herewith.

1. A method of concurrent visualization of serial and parallel consequences of a flow input to a process module of a flow process, the method comprising the steps of:
(a) arranging a plurality of process modules in a system and flow relationship to each other;
(b encapsulating each module within an input/output interface through which module operating requirements and process-specific options may be furnished as inputs to said interface, and parallel and series responses to said inputs may be monitored as outputs of said interface, each input/output interface thereby defining a process action of said module;
(c) providing a process-specific input to said interface of a module of interest;
(d) visually mapping, by rows, of selected module interface outputs, of a selectable subset of modules of said flow process, to be visualized, said mapping extending from a common vertical axis, in response to said process-specific input to said interface, in which a horizontal axis of said mapping comprises a parameter of a serial or parallel consequence of said process-specific input; and
(e) visually comparing time dependent simulated outputs of said interfaces of said selected subset of modules to thereby observe serial and parallel consequences of said process-specific input of said Step (c).

2. The method as recited in claim 1, further comprising:
(f) changing said process-specific input to a selected process module interface;
(g) reiterating said mapping Step (d) above;
(h) reiterating said comparing Step (e) above.

3. The method as recited in claim 1, in which said output monitoring sub-step of said Step (b) comprises:
monitoring of a parameter of interest of said subset of modules including, without limitation, time, cost, quality and physical resources.

4. The method as recited in claim 3, further comprising:
(f)changing said process-specific input to a selected process module interface;
(g) reiterating said mapping Step (d) above;
(h) reiterating said comparing Step (e) above.

5. The method as recited in claim 4, further comprising:
(i) optimizing a particular interface output, or combination thereof, responsive to reiterations of said Steps (f) to (h) above.

6. The method as recited in claim 5 in which said process flow module comprises:
a module of a concurrent simulation software language.

7. The method as recited in claim 6, in which said module comprises:
a hardware design language.

8. The method as recited in claim 6, further comprising the step of:
recognizing a non-optimal interface output of a parameter of a module of interest.

9. The method as recited in claim 3, in which:
one of said inputs to said module interface comprises a “start” signal.

10. The method as recited in claim 9, in which:
one of said operating requirements of said inputs to said module interfaces comprises local resources and constraints.

11. The method as recited in claim 4, in which:
at least one of said operating requirements of said inputs to said module interfaces comprises global policies and constraints.

12 The method as recited in claim 3, in which one of said outputs comprises a status signal.

13. The method as recited in claim 3, in which one of said outputs comprises an estimate of cost.

14. The method as recited in claim 1, in which said consequences comprises a communication.

15. The method as recited in claim 3, in which said consequences comprises a communication.

16. The method as recited in claim 8, in which said consequences comprises a communication.

17. The method as recited in claim 4 in which one or more modules comprises:
a sub-process.

18. The method as recited in claim 4 in which one or more modules comprises:
a person in which the capabilities thereof comprise inputs to said module interface.

19. The method as recited in claim 17, further comprises the step of:
interposing a filter means after outputs of at least one of said re-iteration means.

20. The method as recited in claim 18, further comprises the step of:
interposing a filter means after outputs of at least one of said re-iteration means.
